(19) United States
(12) Patent Application Publication
(10) Pub. No.: US 2005/0038961 A1
(43) Pub. Date: Feb. 17, 2005

(54) Cache and memory architecture for fast program space access

(76) Inventor: Chao-wu Chen, San Jose, CA (US)

Correspondence Address: Bo-In Lin, 13445 Mandoli Drive, Los Altos Hills, CA, 94022, US

(21) Appl. No.: 10/916,089

(22) Filed: Aug. 10, 2004

Related U.S. Application Data
(60) Provisional application No. 60/494,405, filed on Aug. 11, 2003.

(51) Int. Cl. G06F 12/00

(52) U.S. Cl. 711/118; 711/168

(57) ABSTRACT

A data handling system includes a memory that includes a cache memory and a main memory. The memory further includes a controller for simultaneously initiating two data access operations to the cache memory and to the main memory by providing a main memory access address with a time-delay increment added to a cache memory access address based on an access time delay between an initial data access time to the main memory relative to the cache memory. The main memory further includes a plurality of data access paths divided into a plurality of propagation stages interconnected between a plurality of memory arrays in the main memory wherein each of the propagation stages further implementing a local clock for asynchronously propagating a plurality of data access signals to access data stored in a plurality memory cells in each of the main memory arrays. The data handling system further requests a plurality sets of data from the memory wherein the cache memory is provided with a capacity for storing only a first few data for the plurality sets of data with remainder of data of the plurality sets of data stored in the main memory and the main memory and the cache memory having substantially a same cycle time for completing a data access operation.

This application claims priority to pending U.S. patent application entitled “A NEW CACHE AND MEMORY ARCHITECTURE FO FAST PROGRAM SPACE ACCESS” filed Aug. 11, 2003 by Chao-Wu Chen and accorded Ser. No. 60/494,405 the benefit of its filing date being hereby claimed under Title 35 of the United States Code.

### BACKGROUND OF THE INVENTION

1. Field of the Invention

This invention relates generally to apparatuses and configuration for data access to a cache and main memory for a computer system. More particularly, this invention relates to new and improved cache and memory architecture to enable a computer processor to achieve higher speed data access by reducing the size of a cache memory by taking advantage of a semiconductor memory with shortened data cycle time such that high performance system can be implemented with reduced production cost.

2. Description of the Related Art

Conventional technologies of data access for a central processing unit (CPU) to read and write data from and to a main memory by using a high speed cache memory is faced with the limitations that the size of the cache memory may become a bottleneck that hinders the speed of the CPU operations. On the one hand, the CPU is becoming faster and more powerful. On the other hand, the cache memory is very expensive while the price of the computers is becoming lower due to severe market competitions. In order to reduce the production cost, the size of the cache memory must be kept to its minimum. However, small size cache memory may hinder the CPU operations and adversely affect the system performance if the CPU cannot timely access the required data and instructions for high-speed operations. A system designer is therefore confronted with a difficulty to provide high performance system by implementing a cache memory having adequate size to keep up with the high-speed CPU while maintaining low level of production cost.

FIG. 1 is a block diagram for illustrating the sequential flows of data access process implemented with a fast cache memory 20 between a central processing unit (CPU) 30 and a large main memory 40 controlled by a controller 50. The CPU is operating at high speed and requires a high-speed data access. Due to the large main memory has a slow operation speed; direct interaction between the CPU 30 and the main memory 40 will slow down the CPU operations. In order to maintain the CPU operation speed, a cache memory that has a higher speed of operation is implemented to comply with the CPU speed. The controller 50 controls the operation of retrieving data from the main memory 40 to the cache memory 20 and ready for access by the CPU 30. However, since the cache memory 20 is more expensive, it is not economical to implement a large cache memory. A system designer has to compromise between the system operation speed and the cost to balance between a cache memory 20 of an adequate size to maintain a reasonable operational speed without increasing the production cost by using a large size cache memory 20 to maintain the system at a reasonable cost.

Therefore, a need still exists in the art to provide an innovative system configurations and data access method to enable a system designer to overcome such limitations.

### SUMMARY OF THE INVENTION

Therefore, it is an object of the present invention to provide a new and improved memory configuration with a cache memory having a significantly reduced size and a main memory operated with much shorted cycle time such that a central processing unit perform a data access for only the first few data items to the cache memory and branching to the main memory after the data access to the cache memory for the first few data items are completed. The memory control therefore predicting the address of the data access to the main memory based on the delay of the initial access time to the main memory relative to the cache memory. The difficulty of requiring a large cache in order avoid a bottleneck of data process flow because of slow data access operations are therefore resolved. The cache memory can be implemented with much reduced size and direct data access can be performed directly to the main memory without adversely affecting the operation speed of a computer.

Briefly, the present invention discloses a method for accessing data stored in a cache memory and a main memory. The method includes a step of initiating two data access operations to the cache memory and also to the main memory by providing a main memory access address with a time-delay increment added to a cache memory access address based on an access time delay between an initial data access time to the main memory relative to the cache memory.

In accordance with the invention, a data handling system is disclosed. The data handling system includes a memory includes a cache memory and a main memory wherein the memory further includes a controller for simultaneously initiating two data access operations to the cache memory and to the main memory by providing a main memory access address with a time-delay increment added to a cache memory access address based on an access time delay between an initial data access time to the main memory relative to the cache memory. In a preferred embodiment, the main memory further includes a plurality of data access paths divided into a plurality of propagation stages interconnected between a plurality of memory arrays in the main memory wherein each of the propagation stages further implementing a local clock for asynchronously propagating a plurality. of data access signals to access data stored in a plurality memory cells in each of the main memory arrays. In another preferred embodiment, the data handling system further requesting a plurality sets of data from the memory wherein the cache memory having a capacity for storing only a first few data for the plurality sets of data with remainder of data of the plurality sets of data stored in the main memory. In another preferred embodiment, the main memory and the cache memory having substantially a same cycle time for completing a data access operation.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1 is a block diagram for showing a conventional configuration to implement the Conventional Main Memory and Cache Access Scheme.

FIG. 2A is functional block diagram for showing the data access management configuration of this invention implemented with a smaller cache memory and a main memory operated with an asynchronous propagation pipeline memory access process with significantly shortened memory cycle time.

FIG. 2B is a two-dimensional layout of a memory that includes multiple memory arrays with interconnected lines as data access paths each includes multiple stages each stage manage a data access signal propagation based on a local clock for asynchronously propagating the data access signals.

FIG. 2C is a functional block diagram for showing the dual input ports and dual output ports implemented for the main memory asynchronously propagating the data access signals through multiple stages among the memory arrays of FIG. 2B.

FIG. 3 is a timing diagram for a basic memory read process.

FIG. 4 is a timing diagram for a memory read process of this invention when there is a “cache hit” in the data access process.

FIG. 5 is a timing diagram for a memory read process of this invention when there is a “cache miss” in the data access process.

### DETAILED DESCRIPTION OF THE PREFERRED EMBODIMENT

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention. Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

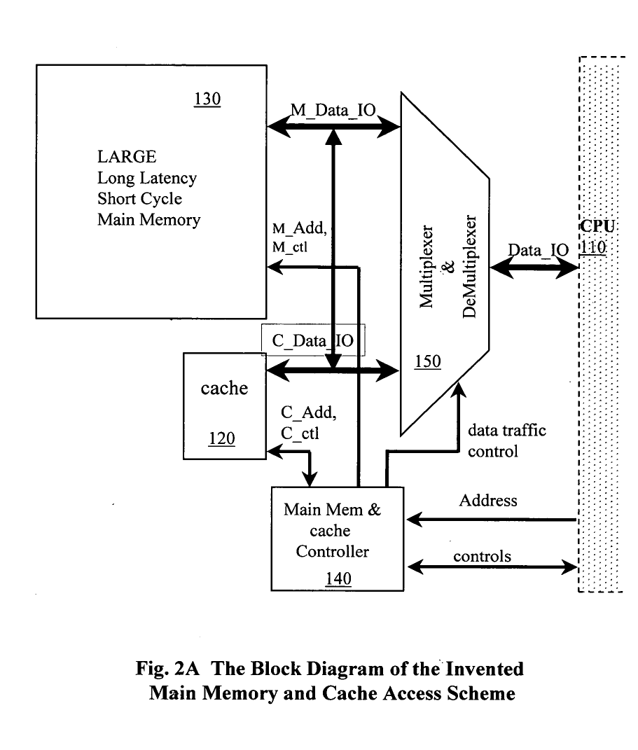

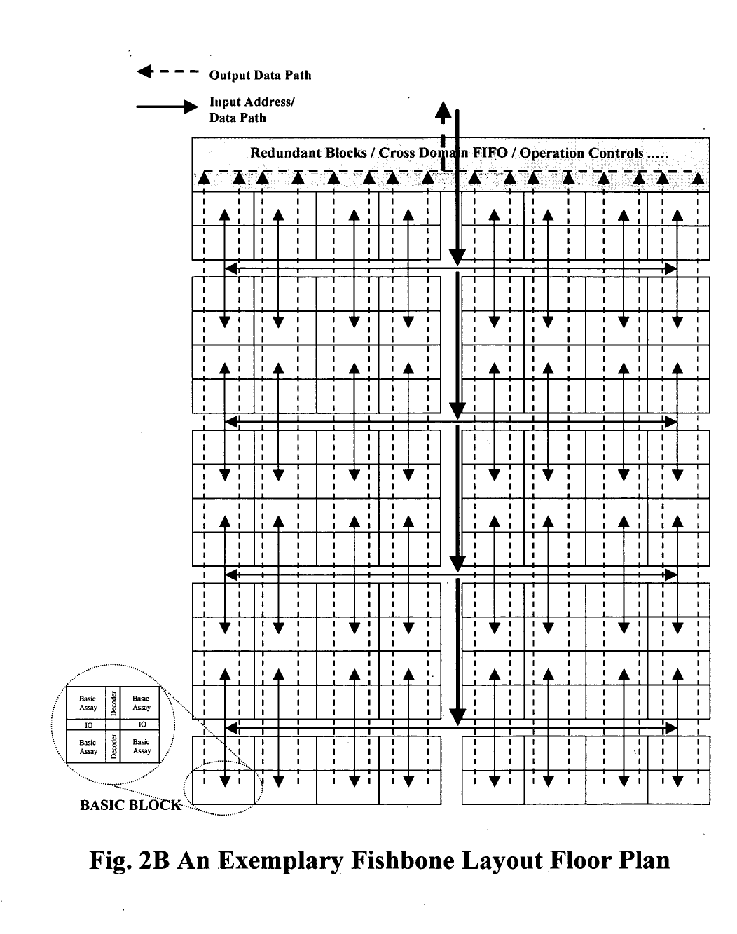

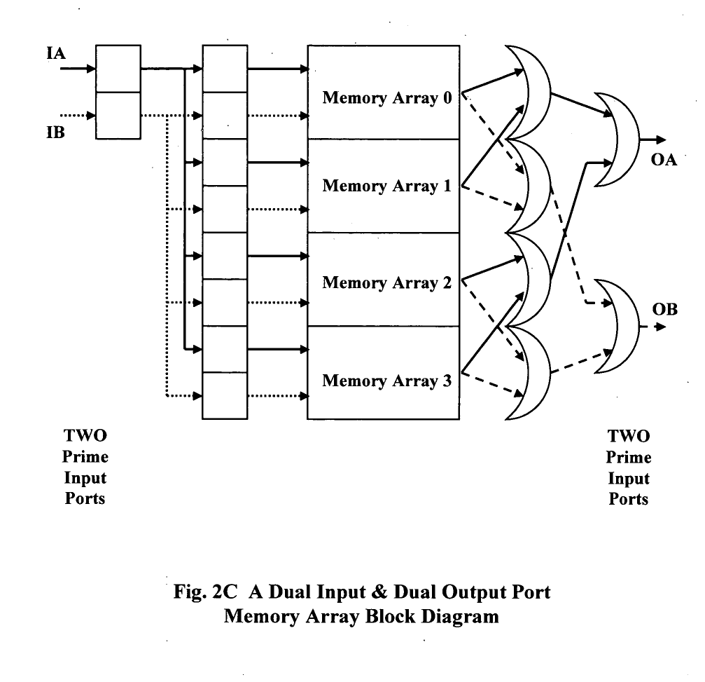

Referring to FIG. 2A for a functional block diagram for showing the data access and control processes for a high-speed central process unit (CPU) 110 implemented with a cache memory 120 of a reduced memory capacity, e.g., 32KB, and a large main memory 130, e.g., a storage capacity of 16 MB. A memory controller 140 controls the data access to the main memory 130 and the cache memory 120 that generates all of address and controls signals to both main and cache memory, and it also directs the data flow between and within the main/cache memory subsystem to and from CPU. A MUX/DMUX device 150 for multiplexing/demultiplexing data access operations is implemented to allow the CPU 110 to retrieve data either from the cache memory 120 or from the main memory 130.

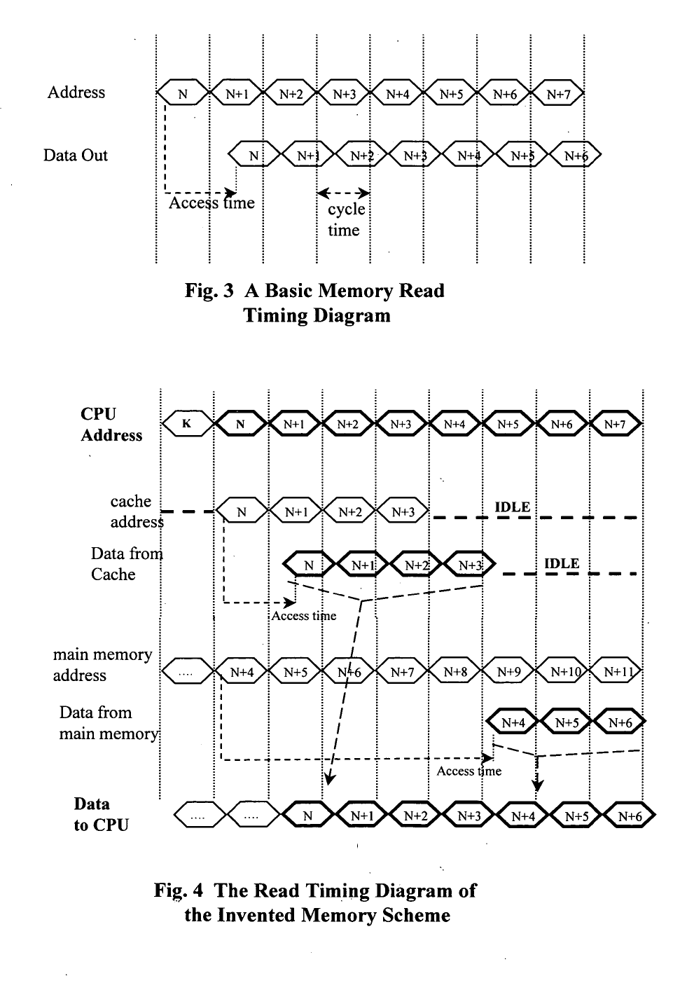

In a data access process, the speed of data access involve the length of two kinds of operations, namely there are 1) the access time that is required to reach the specific location of data storage to start reading or writing the data and the time required to read or write the data; and 2) the cycle time that is the time between this data access operation and a subsequent data access operation, e.g., data retrieval or recording, may start to operate. FIG. 3 is a timing diagram for showing the access time and the cycle time when an address is received by a memory controller to start a data access operation. The number “N” in address field represent an access address for illustrating that the location for the data storage is at a location with an address represented by “N”, and the “N” in data represents that the data is retrieved from a memory location with an address represented by “N”.

The data access system shown in FIG. 2A is implemented with a special main memory that is described in two co-pending Patent Application 60/494,410 and filed by a same inventor of this invention on Aug. 11, 2003 and the disclosure made in the Application 60/494,410 is hereby incorporated by reference in this Patent Application. The main memory 130 has a moderate long access time, e.g., about 4 cycles of access time, as shown in FIG. 4 that will be further explained below. The main memory 140 as that described in the co-pending Patent Application has a very fast cycle time, e.g., 0.5 nano-seconds. With this shortened cycle time, the main memory 130 is therefore provides sufficient speed to directly communicate with the CPU and the cache memory without unduly slowing down the CPU processes or the read/write operations of the cache memory once the initial data access time is over. FIG. 2B shows a two dimensional layout of a main memory according to the co-pending Patent Application wherein the main memory further includes a plurality of data access paths, e.g., the interconnected lines to reach the memory arrays. The data access paths are divided into a plurality of propagation stages interconnected between a plurality of memory arrays in the main memory. Each of the propagation stages further implements a local clock for asynchronously propagating a plurality of data access signals to access data stored in a plurality memory cells in each of said main memory arrays. The cycle time is therefore is not dependent on the longest cycle time of the propagation stages but rather on the difference of the delay time among all the propagation stages. A properly adjustable time delay is therefore implemented in each propagation stage to minimize the difference between the time delays among all the propagation stages to enable the main memory 130 to achieve a much shorter cycle time. With this specially configured main memory implemented with asynchronous propagated data access signal through the data access paths as signal pipelines, the cycle time of the main memory is substantially the same as that of the cache memory 120.

It is a general understanding that there is a fixed pattern for the data access operations by the CPU 110 for recording or retrieving data from a memory in executing a program, i.e., access form a program space. The data access often involves the accessing address, the program counter or the instruction pointer. The program counter may jump to a different location when there is a branch during the execution of a program. Since the branch operations does not frequently occur during a data access process, the data access operation generally read or write data near a specific memory storage address and the operations are generally predictable once an initial data access operation is completed. Based on this more predictable data access patterns as often required by the CPU, the present invention as that shown in FIG. 2A is implemented with a reduced cache size to read first few instructions from the small but very fast cache with short access time without delaying the CPU operations. In the meanwhile, when the first few instructions are retrieved from the cache memory 120, a data retrieval operation is branched to an access data stored in the main memory 130 with an address predicted from the first few instructions. For example, if the first instruction is to access data from address N and the first four addressable data are to read from the cache memory, then a predictable branch to access data from the memory is jumped to an address N+4.

Therefore, the memory controller 140 is implemented to generate two threads of data access requests at the beginning of each branch. The data access requests are sent to the cache memory for the first M addresses and for the data starting from address N+M where N is the starting address of the CPU branch location as a new data access request. The data from the first M addresses are obtained from the cache memory 120 and the first M cycles of data retrieval from the cache memory are allowed as access time delay to reach the location N+M of the main memory 130 to begin a data read operation from that predicted location. Since the main memory of this invention has a high speed cycle time, the remaining instructions can be retrieved from the main memory without requiring a cache memory to store all these instructions. The size of the cache memory can be significantly reduced without sacrificing the speed of operations.

The memory controller 140 performs the functions of directing the data flow between the main memory 130 and the cache 120 and the CPU 110. The controller further controls the prediction of branching to the main memory once a branch operation is initiated from the CPU 110. Besides these two tasks, the controller 140 also needs to perform certain cache related operations such as, creating a new cache entry, write back a cache entry, and maintaining or executing cache update algorithm.

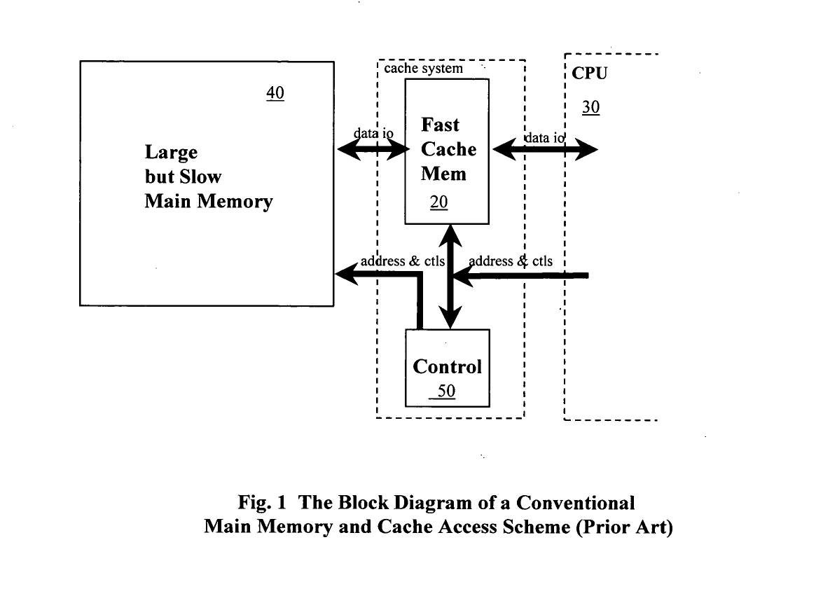

Because only the first few instructions, “M”, per branch or per instruction stream are stored in the cache memory, small or moderate size cache memory is enough. And also because most of the instructions are still in the main memory, very little data move or data swap between cache and main memory will be needed and thus dramatically improve the effective computer performance. Also because much bigger size memory can be placed in the main memory 130 that may have three to twenty times of the storage capacities depending on the types of memory implemented, e.g., SRAM, DRAM, ROM, EPROM, EEPROM or FLASH ROM, etc. The main memory 130 can either be a big memory structure or multiple pages of smaller memory structures. Here, the main memory 130 has a address configuration with consecutively-addressed-locations to prevent unnecessary access time delays by continuous retrieving data from consecutive locations in the main memory without requiring branching to non-consecutive locations. The main memory 130 implemented in the sequential access process of this invention is therefore different from the conventional discrete random pieces of data pointed by the addresses in tag in the conventional cache such as the one in FIG. 1.

With a cache memory 120 having a reduced size, further reduces the needs to do memory swapping or page swapping, which happens between the memory subsystem and the mass storage devices. Therefore, the new configuration as described above provides the advantages of combining both the large main memory and the fast cache memory, effectively makes a very large cache/main memory subsystem with only one cycle long access time. The improved configuration and the novel sequence of memory access operations dramatically improve the overall system performance.The new configuration and data access processing sequence are limited to single chip application. It can apply to a much bigger multi-chip system as long as CPU communicates directly with both main and cache memory according to the invention described above. In multiple chip cases, the CPU, or the memory requester, communicates with a multi-chip memory subsystem which comprises the controller, the cache memory and the external special main memory chip(s) or module(s), where the controller and cache can reside on the CPU chip, or on a separate chip, or even on the memory chips.

According to above descriptions for FIG. 2A, this invention discloses a sequential memory access process with a configuration that includes four basic functional units. Namely, these four basic functional units are: 1.) a main memory 130 which, in general, is very fast, in terms of cycle time, but with rather long, more than one cycle, access time as that disclosed in a co-pending Application 60/494,410 and will be briefly described below, 2.) a cache 120 that is used to store the first few instructions in instruction streams or the first few data pieces of sequential data streams, 3.) the controller logic 140, which is responsible for controlling the main memory and the cache, as well as interfacing with the external memory service requester, such as CPU 110, and 4) the DeMUX and MUX portion 150, which directs the data flow to and from the external memory requester, e.g., the CPU 110, and within the memory apparatus as shown in FIG. 2A.

The controller 140 is implemented to control the main memory 130 and cache memory 120, the temporal data buffering, and directing the internal and external traffic flow, as well as keeping and tracking each of the instruction and the sequential data stream status. The control logic of the memory controller 140 is implemented to track and control either a single thread, e.g., either instruction or sequential data stream, needs to be handled at one time, or to monitor and control multiple threads of data access operations, e.g., more two instruction streams or data streams are tracked and managed simultaneously. The main memory 130 may have a single input and output port, or the main memory may be implemented with multiple input and output ports, e.g., a dual input ports and dual output port main memory shown in FIG. 2C, by providing physical interfaces and control logic to simultaneously process multiple sets of addresses, multiple sets of control signals, and multiple sets of input and output data. For example, in a memory structure, where both the instruction and the data are stored, two threads of status tracking may be used, one for tracking the program instruction stream and the other for tracking the sequential data stream. This way there will be no logic or timing interruption during switching between data and instruction streams. Also, this two thread access may either be implemented with the single port main memory where the instruction access and the sequential data access share the same physical port or may be implemented with the two port main memory structure where both of the instruction access and sequential data have their own dedicated port. Of course, this shared memory access may still function properly when implemented with the single port and single thread access where the controller 140 does not distinguish the instruction from the data flow and only keeps and tracks the current stream status.The cache memory when implemented with the sequential access scheme of this invention as described above is used for temporarily buffering only the first few locations of data of the instruction or the sequential data streams. To effectively implemented the sequential data access process to two different memory devices, the cache memory 120 includes a data memory array or memory arrays to store the actual partial data of the instruction or the data streams. The cache memory 120 further includes a tag memory or tag memories to store the corresponding starting address of the temporarily stored partial data. The cache memory 120 further includes an address comparator to check whether the current address or the current starting address of a new instruction or a new data stream and the corresponding tag address or tag addresses are matching or not. One thing needs to be specially noted is that, this cache does not need to store the whole instruction and the whole sequential data streams, it only stores the first few locations of information of any stream. Similarly, the tag memory does not needs to store all of the corresponding addresses and, in most cases, it only stores the starting addresses of the instruction stream and the data streams. Therefore, the size requirement of the cache memory 120 is small, compared with the conventional cache scheme in FIG. 1. Hence, the cache memory 120 can be easily made very fast and can be compatible with any fast cycle time main memory.It is also a common knowledge that besides the consecutive instruction cycle accesses, the CPU 110 also needs to access large amount of sequential data by executing a block data access operation. This invention covers also the multiple port read/write operations by making the main memory to function in a multiple streams of instruction and data simultaneously. Furthermore, for simplified design and integrated functional blocks to achieve space savings, it may be desirable to merge the controller logic 140, the DeMUX and MUX portion 150 with the cache memory 120 to form a bigger controlling and buffering module as an application specific integrated circuit (ASIC) chip or a multiple-chip module (MCM) instead

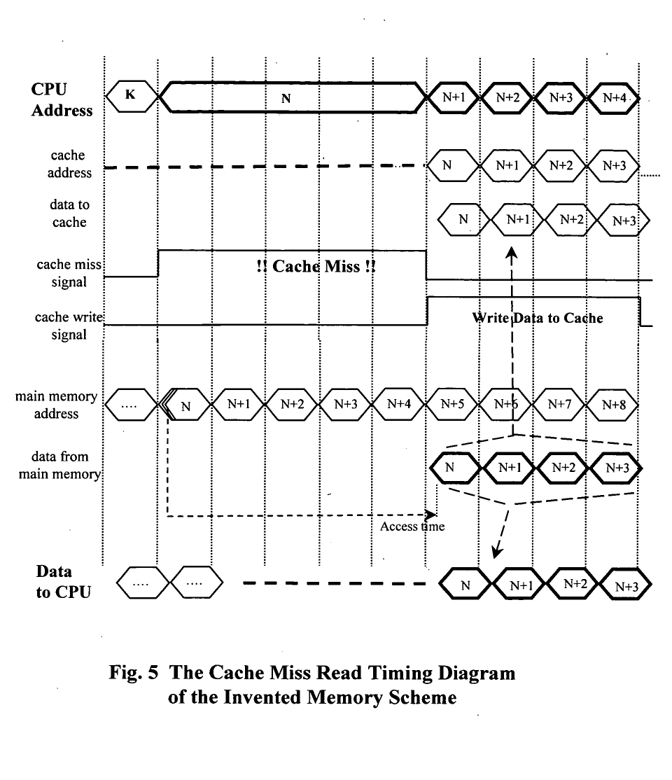

FIG. 4 is a timing diagram for showing the basic read timing of the data access process of this invention with the cycle time of the main memory, the cache memory, and CPU are the substantially the same. As shown in the Figure, the initial four addresses are retrieved from the cache memory when the address sent to main memory is “N+4”, assuming main memory access time is 4 cycle longer than the cache access time. With this scheme, every time after the branch, where CPU address changes from K to N in FIG. 4, the first 4 instructions will be fetched from the cache memory side and the remaining instructions will be retrieved from the main memory until next branch happens. Of course, the above scheme assumes there is a cache hit after the branch to address N, that means the first 4 instructions were already in the cache memory before branching to N, so the first 4 instructions can be immediately sent through MUX/ DeMUX to CPU. Referring to FIG. 5 for the circumstance when the branch cache data access misses, i.e., the first 4 instructions can not be found in the cache memory and cache memory sends a “cache miss” signal to CPU and the controller. The controller then will send an address of N to the main memory 130 where N represents the current CPU address and it will wait four cycles before fetching the 1st instruction from the main memory side. During the first 4 instructions, the controller will also make a write request to the cache memory and writes the first 4 instructions in a new cache entry with tag address N in the cache 120. With this new cache entry created, next time, when CPU branch to this location, N, it will be a cache-hit situation rather than a cache-miss.

By the way, the invention is not certainly restricted to the number “4” described in FIG. 4 and FIG. 5, it can be any number which represents the access time to the cycle time ratio or the required cache entry length. Of course, it is also possible to use wait-state and shorter cache entry to reduce the required cache entry length, as long as the data flow from the cache side and the data flow from the main memory side can be properly chained by the CPU or by any memory-requesting device. In fact, the sequential access scheme as discussed above can also be applied to other special memory access scheme, as long as this memory access pattern or, more accurately, the address stream pattern can be predicted by the controller logic 140. Specifically, the controller 140 predicts the address for data access in the main memory 130 and also the advance time to start retrieve data from the predicted address in the main memory 130. The data access from the main memory 130 starts before the completion of the data access from the cache memory in anticipating to supply data directly from the main memory 130 to the CPU 110 right after the completion of the data access from the cache memory 120 such that there is a seamless and continuous data access operation to maintain the high speed operation of the CPU 110 without interruptions.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A data handling system having a memory comprising a cache memory and a main memory wherein said memory further comprising:
a controller for simultaneously initiating two data access operations to said cache memory and to said main memory by providing a main memory access address with a time-delay increment added to a cache memory access address based on an access time delay between an initial data access time to said main memory relative to said cache memory.

2. The data handling system of claim 1 wherein:
said main memory further comprising a plurality of data access paths divided into a plurality of propagation stages interconnected between a plurality of memory arrays in said main memory wherein each of said propagation stages further implementing a local clock for asynchronously propagating a plurality of data access signals to access data stored in a plurality memory cells in each of said main memory arrays.

3. The data handling system of claim 1 wherein:
said data handling system further requesting a plurality sets of data from said memory wherein said cache memory having a capacity for storing only a first few data for said plurality sets of data with remainder of data of said plurality sets of data stored in said main memory.

4. The data handling system of claim 1 wherein:
said main memory and said cache memory having substantially a same cycle time for completing a data access operation.

5. The data handling system of claim 1 wherein:
said cache memory further includes a tag memory for storing said main memory access address generated from adding said time-delay increment to said cache memory access address based on said access time delay between of said main memory relative to said cache memory.

6. The data handling system of claim 5 wherein:
said tag memory further includes a length of data whereby said controller initiating a main memory data access starting from said main memory access address and completing said data access by accessing data over said length of data in said main memory.

7. The data handling system of claim 1 wherein:
said controller further tracking and controlling multiple-threads of data access operations.

8. The data handling system of claim 1 wherein:
said main memory further comprising a single input and output ports.

9. The data handling system of claim 1 wherein:
said main memory further comprising a multiple input and output ports.

10. The data handling system of claim 1 wherein:
said memory cells in said main memory further comprising dynamic random access memory (DRAM) cells.

11. The data handling system of claim 1 wherein:
said memory cells in said main memory further comprising static random access memory (SRAM) cells.

12. The data handling system of claim 1 wherein:
said memory cells in said main memory further comprising static read only memory (ROM) cells.

13. The data handling system of claim 1 wherein:
said memory cells in said main memory further comprising programmable read only memory (PROM) cells.

14. The data handling system of claim 1 wherein:
said memory cells in said main memory further comprising erasable programmable read only memory (EPROM) cells.

15. The data handling system of claim 1 wherein:
said memory cells in said main memory further comprising FLASH memory cells.

16. The data handling system of claim 1 wherein:
said memory cells in said main memory further comprising a multiple-paged memory.

17. The data handling system of claim 1 further comprising:
a central processing unit (CPU) for requesting a data access to said memory.

18. The data handling system of claim 1 wherein:
said controller further comprising a demultiplexing and multiplexing (MUX-DEMUX) circuit for directing a data flow from and to a data access requester from said memory.

19. The data handling system of claim 1 wherein:
said controller and said cache memory are integrated as an application specific integrated circuit (ASIC).

20. The data handling system of claim 1 wherein:
said controller further comprising a demultiplexing and multiplexing (MUX-DEMUX) circuit for directing a data flow from and to a data access requester from said memory; and
said controller and said cache memory are integrated as a multiple chip module (MCM).

21. A method for accessing data stored in a cache memory and a main memory comprising:
initiating two data access operations to said cache memory and to said main memory by providing a main memory access address with a time-delay increment added to a cache memory access address based on an access time delay between an initial data access time to said main memory relative to said cache memory.
